(19) United States
(12) Patent Application Publication
(10) Pub. No.: US 2026/0093601 A1
(43) Pub. Date: Apr. 2, 2026

(54) GENERATING STATIC DEFECT CHECKERS USING A LANGUAGE MODEL

(71) Applicant: Oracle International Corporation, Redwood Shores, CA (US)

(72) Inventors: Cristina CIFUENTES, Forest Lake (AU); Isaac BEH, Bisbane (AU); Kirra FLETCHER, Brisbane (AU); Jonathan FUNG, Brisbane (AU)

(73) Assignee: Oracle International Corporation, Redwood Shores, CA (US)

(21) Appl. No.: 18/900,628

(22) Filed: Sep. 27, 2024

(51) Int. Cl. G06F 11/36

(52) U.S. Cl. CPC G06F 11/3608

(57) ABSTRACT

A method generates static defect checkers using a language model. The method includes generating an example representation. The method further includes combining an explanation section, an instruction section, and a description section to generate a prompt. The explanation section includes the example representation, the instruction section includes instruction text, and the description section includes defect description text. The defect description text includes a natural language description of a defect corresponding to the example representation. The explanation section includes operations corresponding to the defect. The instruction text includes instructions in the natural language to generate defect checker code using the example representation and the defect description text. The method further includes executing a language model using the prompt to generate the defect checker code. The defect checker code is in a programming language.

### BACKGROUND

Prompt engineering is a rapidly growing field investigating how various prompting techniques can illicit improved results from a large language model (LLM). Considerable effort has been made in developing specialized prompt templates, frameworks and fine-tuned models that successfully solve niche problems. One problem is the writing of static defect checkers, which are tools that check statically for specific types of defects, including vulnerabilities and bugs. A bug is a defect that may be a logical error in a software application, which may be due to the facilities available in the programming language used to write the software. A vulnerability is a security bug, i.e., a bug that, potentially, may be exploited by malicious actors to obtain private data stored in the software, or other security-related concerns.

Software may include defects that may be either intentionally written into the software (i.e., a malicious actor) or unintentionally written by the developer due to lack of suitable security abstractions being available in programming languages. Static program analysis may use static defect checkers to identify potential defects in source code, involving a variety of techniques including control flow and data flow analysis. The use of automated static analysis tools with corresponding static defect checkers helps with identifying some of these defects ahead of deployment of the software into production which may prevent exploitation of such defects in production. However, the development of static analysis tools is time consuming and may also create defect checkers within these status analysis tools that have defects (bugs and vulnerabilities).

### SUMMARY

In general, in one or more aspects, the disclosure relates to a method that generates static defect checkers using a language model. The method includes generating an example representation. The method further includes combining an explanation section, an instruction section, and a description section to generate a prompt. The explanation section includes the example representation, the instruction section includes instruction text, and the description section includes defect description text. The defect description text includes a natural language description of a defect corresponding to the example representation. The explanation section includes operations corresponding to the defect. The instruction text includes instructions in the natural language to generate defect checker code using the example representation and the defect description text. The method further includes executing a language model using the prompt to generate the defect checker code. The defect checker code is in a programming language.

In general, in one or more aspects, the disclosure relates to a system that includes at least one processor and an application that executes on the at least one processor. Executing the application performs generating an example representation; Executing the application further performs combining an explanation section, an instruction section, and a description section to generate a prompt. The explanation section includes the example representation, the instruction section includes instruction text, and the description section includes defect description text. The defect description text includes a natural language description of a defect corresponding to the example representation. The explanation section includes operations corresponding to the defect. The instruction text includes instructions in the natural language to generate defect checker code using the example representation and the defect description text; and Executing the application further performs executing a language model using the prompt to generate the defect checker code. The defect checker code is in a programming language.

In general, in one or more aspects, the disclosure relates to a non-transitory computer readable medium including instructions executable by at least one processor. Executing the instructions performs generating an example representation. Executing the instructions further performs combining an explanation section, an instruction section, and a description section to generate a prompt. The explanation section includes the example representation, the instruction section includes instruction text, and the description section includes defect description text. The defect description text includes a natural language description of a defect corresponding to the example representation. The explanation section includes operations corresponding to the defect. The instruction text includes instructions in the natural language to generate defect checker code using the example representation and the defect description text.

Executing the instructions further performs executing a language model using the prompt to generate the defect checker code. The defect checker code is in a programming language.

Other aspects of one or more embodiments may be apparent from the following description and the appended claims.

### BRIEF DESCRIPTION OF DRAWINGS

FIG. 1 and FIG. 2 show diagrams in accordance with the disclosure.

FIG. 3A and FIG. 3B show methods in accordance with the disclosure.

FIG. 4A, FIG. 4B, FIG. 4C, FIG. 5, FIG. 6, and FIG. 7 show examples in accordance with the disclosure.

FIG. 8A and FIG. 8B show computing systems in accordance with the disclosure.

Similar elements in the various figures are denoted by similar names and reference numerals. The features and elements described in one figure may extend to similarly named features and elements in different figures.

### DETAILED DESCRIPTION

Systems and methods of the disclosure generate static defect checkers using a language model. In so doing, the resources used to develop the defect checkers and corresponding static analysis tools may be reduced. Defects within operating system code, general purpose software, and/or cloud software may also be reduced to save further computational resources upon the execution of the defect checkers generated with the language model. Additionally, implementations of the disclosure may yield significant reduction of developer time and resources (e.g., processing, memory, and storage resources) with defect checkers that still run as normal, as if being produced by a human developer. Types of defects that may be analyzed using the systems and methods of the disclosure include defects that may be modeled using finite state machines.

To generate the defect checker, a prompt is generated that includes an explanation section, instruction section, and the description section. The explanation section includes text that may include an intermediate representation of example code, which may include examples of the type of defect being checked. The instruction section includes text that instructs the language model to generate programming language code for a defect checker that checks for the type of defect described in the description section and for which examples are provided in the explanation section. The description section includes text that provides a natural language description of the defect.

The prompt is input to the language model, which outputs the code for a defect checker. The code for the defect checker may be executed with a sample of test code, which may be converted to an intermediate representation in the same manner as the example code. The output of the defect checker may provide a report that identifies whether the test code includes the type of defect that is checked by the defect checker.

Computational systems that implement the disclosure may be improved by generating defect checkers using reduced amounts of resources (processors, memory, network bandwidth, etc.). Additionally, computational systems implementing the disclosure may execute to yield significant reduction of developers time and resources to generate defect checkers that still run as if produced by a human developer. Further, computational systems that implement the disclosure have improved security by executing the programs checked with the defect checkers that have fewer defects, bugs, vulnerabilities, etc.

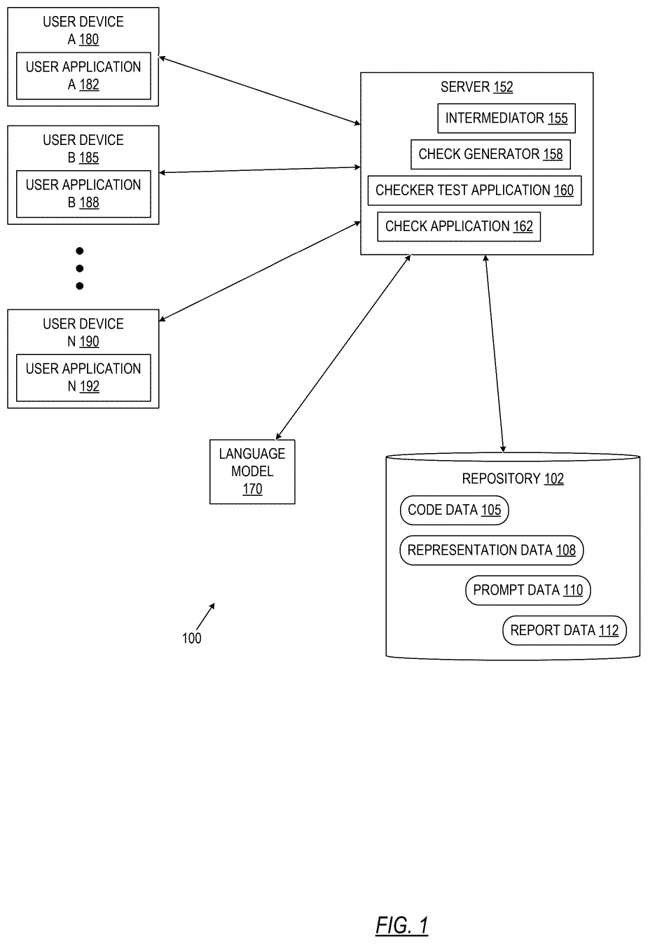

Turning to FIG. 1, the system (100) is an improved computing system that operates to generate static defect checkers using a language model. The components of the system (100) may each include one or more processors and one or more memories with data and instructions in accordance with the computing systems described in FIG. 7A and FIG. 7B. The processors load data and instructions from the memories into registers of the processors, process the data in the registers in accordance with the instructions, and store results in the registers back to the memories. The system (100) includes the server (152) that communicates with the repository (102), the language model (170), and the user devices A (180) and B (185) through N (190).

The repository (102) may be a collection of storage devices (e.g., file systems, databases, data structures, etc.) that store and maintain the data used by the system (100). The repository (102) may include multiple different, potentially heterogenous, storage devices. The repository (102) stores data utilized by other components of the system (100). The data stored by the repository (102) includes the code data (105), the representation data (108), the prompt data (110), and the report data (112).

The code data (105) may be information stored in memory that represents programming language code. Programming language code is a set of instructions written in a programming language that a computer processor may execute to perform tasks. Programming language code is in a structured format that specifies the operations to be performed by machines to process logic, execute processes, and manipulate data. Examples of programming languages include Python, Java, C++, etc. The code data (105) may include source code written in a programming language readable by humans that may be compiled to machine code by computing systems. The code data (105) may include example code, test code, and defect checker code. The example code may be used for examples to prompt the language model (170) to generate defect checker code. The test code may be used to test the defect checker code generated by the language model (170). The defect checker code may be used to check code for a type of defect.

The representation data (108) may be information stored in memory that represents an intermediate representation of the code data (105). An intermediate representation of programming language code may include the intermediate code or data structures used within a compiler that represents a program in between the source code (i.e., the code data (105), readable by humans) and the machine code (operable by machines). An intermediate representation abstracts the operations of a program to a form used to analyze, optimize, and transform the code during the compilation process used to generate machine code from source code.

The prompt data (110) may be information stored in memory that represents the prompts used to generate output from the language model (170). The prompt data (110) may include the prompts sent to the language model (170) from the server (152). The prompt data (110) may also include the responses to the prompts sent from the server (152). A prompt may include natural language and be in the form of input text (or vectors generated from input text) that instructs the language model (170) to generate a specific output. The natural language is a written language used by humans to communicate with each other. Examples of natural languages include English, Spanish, Mandarin Chinese, Japanese, Russian, French, etc. The prompt serves as the initial context or question, shaping the response from the language model (170) by framing the desired output requested from the language model (170). The prompt may describe a type of defect to detect using the output from the language model (170). The response to a prompt may include defect checker code from the language model (170) that is written in a programming language and which may be used to check other code (software, programs, etc.) for defects of the type described in the prompt.

The report data (112) may be information stored in memory that represents generated and stored by the check application (162). Report data (112) may include defect reports in which a defect report may identify the presence of a defect within code tested by the defect checker code and output from the language model (170). A defect report may include a negative or false result when the defect is not found. A defect report may include a positive or true result when the defect is found, and may include additional information related to the defect. The additional information may include the line number related to the defect and include a description of the type of defect.

The server (152) is a collection of one or more computing systems that communicate with the repository (102), the language model (170), and the user devices A (180) through N (190). The server (152) may include multiple components that execute instructions to perform specific tasks using operations within the memory and processors of the server (152). The instructions may be written in programming languages, which may include Python, JavaScript, Java, C++, C#, Ruby, etc., that is compiled to machine code, stored in memory, and executed on the processors. The components may include the intermediator (155), the check generator (158), the checker test application (160), and the check application (162).

The intermediator (155) is a component of the server (152) that may include a software program that generates intermediate representations from programming language code. For example, programming language code from the code data (105) may be converted by the intermediator (155) to an intermediate representation that includes a graph of nodes and edges stored in the representation data (108). The nodes may represent operations from the programming language code and the edges may represent execution paths within the programming language code.

The check generator (158) is a component of the server (152) that may include a software program that assembles prompts and generates defect checker code from the prompts. For example, the check generator (158) may assemble a prompt from text that includes explanations, instructions, and descriptions for a type of a defect and store the prompts to the prompt data (110). The check generator (158) may send the prompt to the language model (170) to generate defect checker code that may be returned to the check generator (158) and stored in the code data (105).

The checker test application (160) is a component of the server (152) and may include a software program that tests the defect checker code. For example, the checker test application (160) may retrieve test code and generate an intermediate representation of the test code (referred to as a test representation). The checker test application (160) may use the check application (162) to check the test code using the test representation and generate a defect report that is saved to the report data (112).

The check application (162) is a component of the server (152) and may include a software program that processes a test representation with defect checker code to determine if the defect is present within the test code represented by the test representation.

The language model (170) is a component of the system (100). The language model (170) may be hosted on a server separate from the server (152). The language model (170) may be a generational artificial intelligence (AI) tool, which may be a large language model (LLM) that includes a deep neural network with millions to billions of parameters. The language model (170) may be trained on large datasets using distributed computing resources to handle the high computational demands. The model architecture may include transformer models with attention layers to process and generate text. During training, the language model (170) learns to predict the next word in a sequence of words. Learning may be optimized through techniques like gradient descent and backpropagation. Post-training, the model may be fine-tuned for specific tasks or domains to enhance its performance in practical applications.

The machine learning models used by the system (100), including the language model (170), may include neural networks and may operate using one or more layers of weights that may be sequentially applied to sets of input data, which may be referred to as input vectors. For each layer of a machine learning model, the weights of the layer may be multiplied by the input vector to generate a collection of products, which may then be summed to generate an output for the layer that may be fed, as input data, to a next layer within the machine learning model. The output of the machine learning model may be the output generated from the last layer within the machine learning model. Multiple machine learning models may operate sequentially or in parallel. The output may be a vector or scalar value. The layers within the machine learning model may be different and correspond to different types of models. As an example, the layers may include layers for recurrent neural networks, convolutional neural networks, transformer models, attention layers, perceptron models, etc. Perceptron models may include one or more fully connected (also referred to as linear) layers that may convert between the different dimensions used by the inputs and the outputs of a model. Different types of machine learning algorithms may be used, including regression, decision trees, random forests, support vector machines, clustering, classifiers, principal component analysis, gradient boosting, etc.

The machine learning models may be trained by inputting training data to a machine learning model to generate training outputs that are compared to expected outputs. For supervised training, the expected outputs may be labels associated with a given input. For unsupervised learning, the expected outputs may be previous outputs from the machine learning model. The difference between the training output and the expected output may be processed with a loss function to identify updates to the weights of the layers of the model. After training on a batch of inputs, the updates identified by the loss function may be applied to the machine learning model to generate a trained machine learning model. Different algorithms may be used to calculate and apply the updates to the machine learning model, including back propagation, gradient descent, etc.

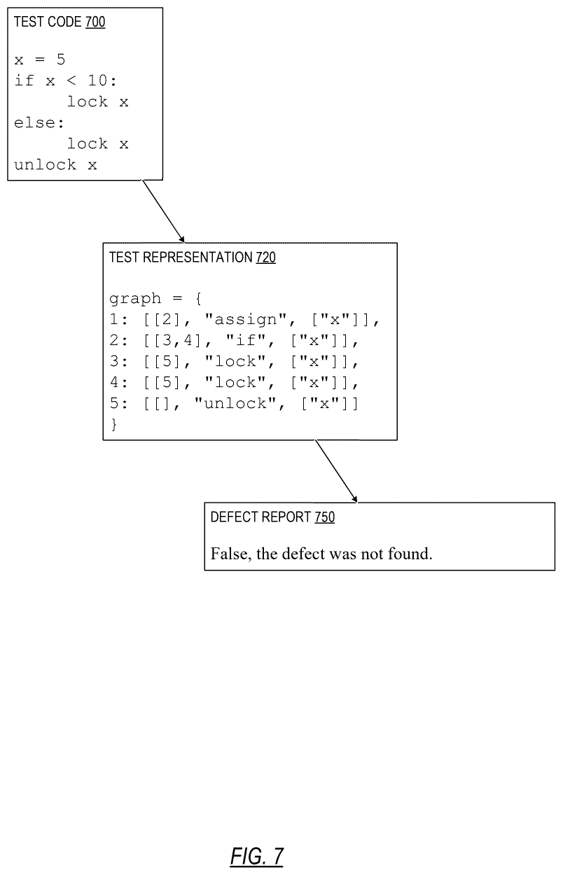

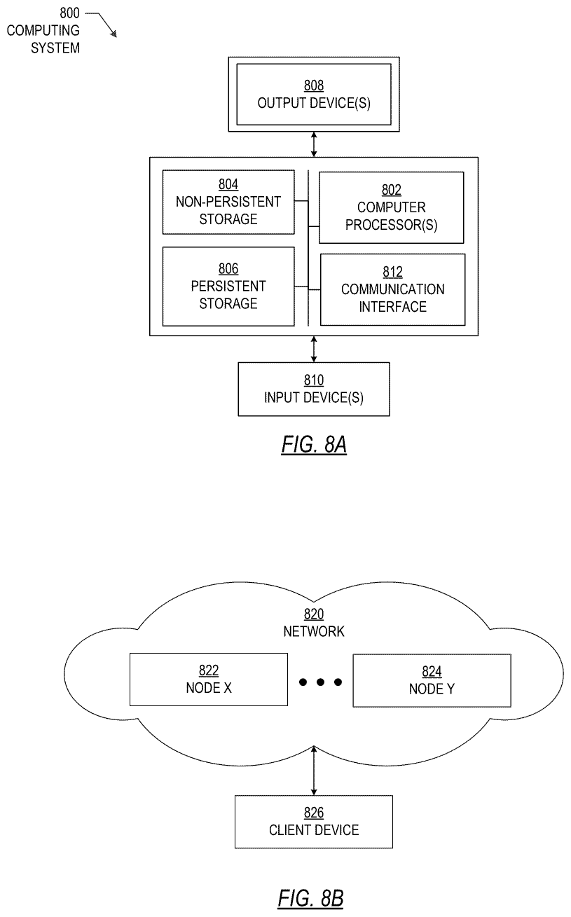

Continuing with FIG. 1, the user devices A (180) and B (185) through N (190) may interact with the server (152). The user devices A (180) and B (185) through N (190) may be computing systems in accordance with FIG. 8A and FIG. 8B. The user devices A (180) and B (185) through N (190) may include and execute the user applications A (182) and B (188) through N (192).

The user applications A (182) and B (188) through N (192) are programs that operate on the user devices A (180) and B (185) through N (190) to provide user interaction by collecting user inputs and displaying outputs in response to the user inputs. The user applications A (182) and B (188) through N (192) may include user interfaces with user interface elements to receive inputs and display outputs to the users of the system (100).

The user device A (180) may be operated by a user to interact with the server (152). For example, the user may interact with a user interface to generate or select explanations, instructions, and descriptions of types of defects. The explanations, instructions, and descriptions may then be used by the server (152) to generate defect checker code.

The user device N (190) may be operated by another user of the system (100) to check code for defects using the defect checker code generated responsive to the user device A (180). For example, the user of the device N (190) may select one or more files of code within the code data (105) to be processed with the defect checker code and initiate the processing of the files with the defect checker code.

Although described within the context of a client server environment with servers and user devices, aspects of the disclosure may be practiced with a single computing system and application. For example, a monolithic application may operate on a computing system (100) to perform the same functions as one or more of the applications executed by the server (152), the language model (170), and the user devices A (180) and B (185) through N (190).

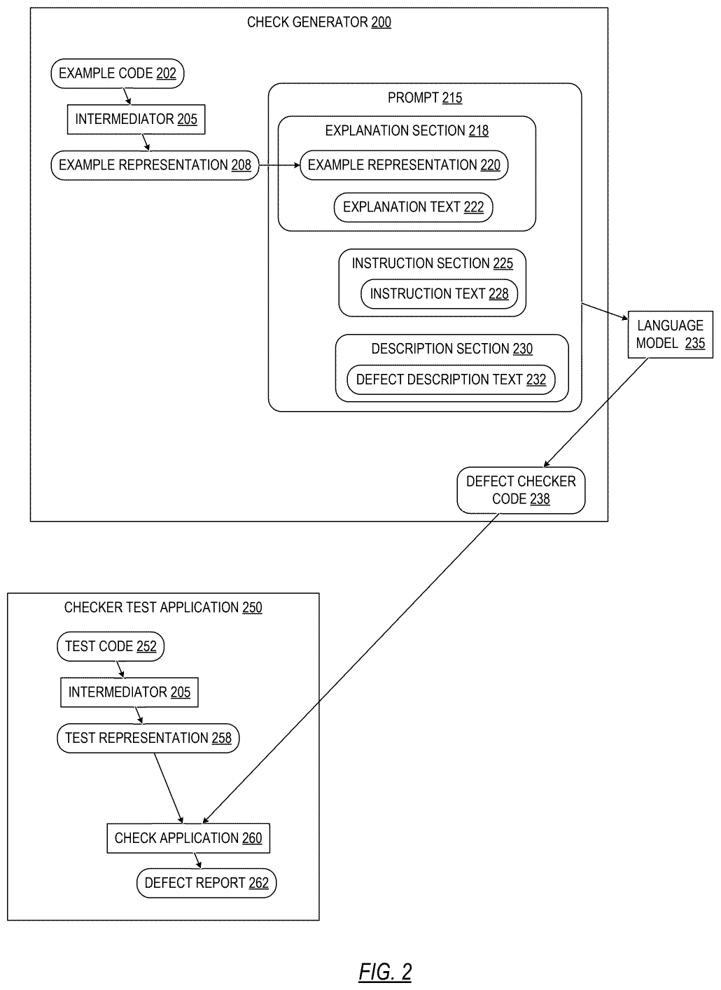

Turning to FIG. 2, the check generator (200) may be an embodiment of the check generator (158) of FIG. 1 and the checker test application (250) may be an embodiment of the checker test application (160) of FIG. 1. The check generator (200) generates the defect checker code (238), which is tested with the checker test application (250). The check generator (200) processes the example code (202), generates the prompt (215), and requests a response from the language model (235) like the defect checker code (238).

The example code (202) may be a sample of programming language text. The example code (202) may be a file, or portion of a file, with code that may be used as an example for generating the defect checker code (238) by the language model (235). The example code (202) may be an input to the intermediator (205).

The intermediator (205) processes the example code (202) to generate the example representation (208). The intermediator (205) may generate a graph which may be formed from an abstract syntax tree. The intermediator (205) may filter the graph to remove extraneous operations and keep operations related to a particular type of defect for which the defect checker code (238) is to be generated. The intermediator (205) outputs the example representation (208).

The example representation (208) may be a collection of text that describes the graph of operations related to a particular type of defect. The example representation (208) may be generated with the intermediator (205). The example representation (208) may be written by a developer, in which case the example code (202) and the intermediator (205) may not be used. The example representation (208) may include descriptions of the nodes and edges of the graph that represents the example code (202). The example representation (208) may be used in the explanation section (218) of the prompt (215).

The prompt (215) is a collection of text that is an input to the language model (235). The prompt (215) includes the explanation section (218), the instruction section (225), and the description section (230).

The explanation section (218) is a section of the prompt (215). The explanation section (218) includes examples for the language model (235). The examples in the explanation section (218) may include positive or negative examples of the type of defect described in the description section (230) and for which the defect checker code (238) is being generated. The explanation section (218) may include the example representation (220) and the explanation text (222).

The example representation (220) is a part of the explanation section (218) that includes intermediate representations of code that may include the type of defect describing the description section (230). The example representation (220) may be fed into the language model (235) as part of a prompt to the language model (235) for the language model (235) to understand the format of data being used. The example representation (220) may be written in a programming language but may not be compilable. The example representation (220) may include the example representation (208) for the example code (202) and may include additional example representations for additional example code.

The explanation text (222) is a part of the explanation section (218) that may describe the contents of the example representation (220) in natural language. For example, the explanation text (222) may identify the type and contents of the data structure used to form the intermediate representation.

The instruction section (225) is a section of the prompt (215). The instruction section (225) includes instructions that may direct the language model (235) to generate the defect checker code (238). The instruction section (225) includes the instruction text (228).

The instruction text (228) is part of the instruction section (225). The instruction text (228) provides instructions written in a natural language to direct the language model (235) to generate the defect checker code (238) based on the contents of the description section (230) and the explanation section (218). The instruction text (228) may include an enumeration of the paths that are possible through the graphs in the example representation (220).

The description section (230) is a section of the prompt (215). The description section (230) includes a description of the type of defect to be checked for with the defect checker code (238). The description section (230) includes the defect description text (232).

The defect description text (232) is part of the description, section (230). The defect description text (232) may include a natural language description of the type of defect that relates to the examples in the explanation section (218). The type of defect may be one that may be identified using a finite state machine. Descriptions for each of the states and transitions of the finite state machine may be included along with descriptions of incorrect or illegal states or transitions. The use of natural language for the description of the defect may reduce the total amount of time to generate the defect checker code (238). Additionally, the natural language description may provide additional nuance that may not be expressible in a language that is not in natural language (e.g., a programming language, a markup language, a graph description language, etc.). Thus, using natural language for the description may improve the accuracy of the defect checker code (238).

The language model (235) is a component that is accessed by the check generator (200). The language model (235) may be separate from the check generator (200) and hosted by a different computer system or maybe an integrated component within the check generator (200). The language model (235) is called by the check generator (200) with the prompt (215) to generate the defect checker code (238). The language model (235) may receive the prompt (215) as text, which is tokenized. The tokens may then be converted to input vectors for the machine learning model of the language model (235). The input vectors may be processed with the machine learning model to generate output vectors. The output vectors may be converted to tokens, which are then converted to text that is sent in a response to the check generator (200). The response includes the defect checker code (238).

The defect checker code (238) is at least part of the output from the language model (235). The defect checker code (238) may include programming language code that may be compiled and executed to determine if a defect of the type described in the description section (230) is present in code being tested. The defect checker code (238) may be extracted from the output of the language model (235) as text. The defect checker code (238) may be an input to the check application (260).

The checker test application (250) may be an embodiment of the checker test application (160) of FIG. 1. The checker test application (250) may generate the defect report (262) from the test code (252) and the defect checker code (238).

The test code (252) may be a sample of programming language text. The test code (252) may be a file, or portion of a file, with code that may be used as a test for the defect checker code (238) generated by the language model (235). The test code (252) may be an input to the intermediator (205).

The intermediator (205), which may be the same as that used by the check generator (200), processes the test code (252) to generate the test representation (258). The intermediator (205) may generate the test representation (258) in the same manner as that of the example representation (208). The intermediator (205) outputs the test representation (258).

The test representation (258) may be a collection of text that describes a graph of the test code (252). The test representation (258) may include descriptions of the nodes and edges of the graph that represents the test code (252). The test representation (258) is an input to the check application (260).

The check application (260) is a component that may include a software program with instructions to check the test representation (258) using the defect checker code (238) to generate the defect report (262). The check application (260) may compile the defect checker code (238) to an executable form. The executable form may then be executed with the test representation (258) to determine if the defect of the type checked by the defect checker code (238) is present in the test representation (258). The output of the determination may be stored in the defect report (262).

The defect report (262) is a collection of information that reports whether the test code (252) includes the defect of the type checked by the defect checker code (238). The defect report (262) may include text that identifies whether the presence of the defect is positive (i.e., the defect is present in the test code (252)) or negative (i.e., the defect is not present in the test code (252)). Each sample of code may include multiple instances of the defect being checked. The defect report (262) may identify each instance of the defect within a sample of code.

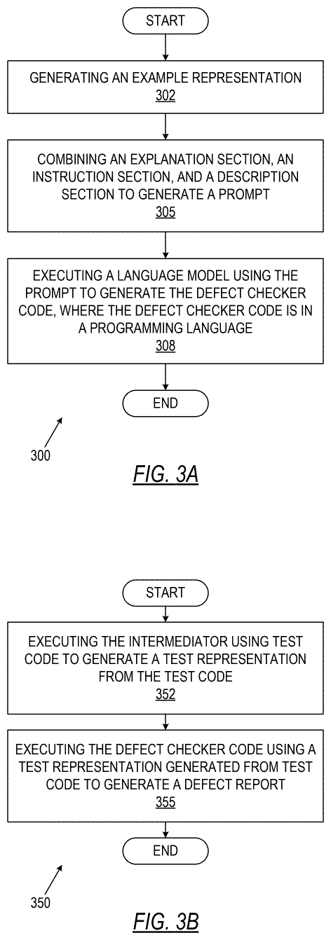

FIG. 3A and FIG. 3B show flowcharts of methods of generating and using static defect checkers using language models. The methods of FIG. 3A and FIG. 3B may be implemented using the system of FIG. 1, and one or more of the steps may be performed on, or received at, one or more computer processors. The system may include at least one computer processor and an application that, when executing on the at least one computer processor, performs the method. A non-transitory computer readable medium may include instructions that, when executed by one or more computer processors, perform the method. The outputs from various components (including models, functions, procedures, programs, processors, etc.) performing the method may be generated by applying a transformation to inputs using the components to create the outputs without using mental processes or human activities.

Turning to FIG. 3A, the process (300) may be part of an application that generates defect checker code. The process (300) may include multiple steps (e.g., steps (302) through (308)) that may execute on the components described in the other figures, including those of FIG. 1.

Step (302) includes generating an example representation. The example representation is an intermediate representation of code that is between source code (written in a programming language) and machine code (operable by a machine).

Generating the example representation may include executing an intermediator using example code to generate the example representation from the example code. To generate the example representation, the intermediator may load the example code from a repository, process the example code to generate the example representation, and store the example representation back to the repository.

Generating the example representation may include converting the example code to a graph including a set of nodes representing operations corresponding to the example code and including a set of edges between the set of nodes representing execution paths within the example code.

Generating an intermediate representation from the programming language code of the example code may include several steps. The source code may be parsed using a lexer and a parser. The lexer may break down the code into tokens, i.e., into sets of one or more characters, which may be keywords, operators, and identifiers. The parser then processes and organizes the tokens into an abstract syntax tree, which represents the syntactic structure of the example code based on the grammar of the programming language in which the example code is written.

After generation, the abstract syntax tree may undergo a transformation process to produce the intermediate representation. The transformation may involve traversing the abstract syntax tree and mapping the nodes of the abstract syntax tree to corresponding elements in the intermediate representation. The intermediate representation may have fewer details than the original source of the example code. The intermediate representation may focus on the operations and data flow that are relevant to the defect being detected without the syntactic details specific to the programming language in which the example code is written. Examples of information in intermediate representations include three-address code, control flow graphs, static single assignment forms, etc.

The intermediate representation may be further optimized through various techniques including constant folding, dead code elimination, and loop unrolling. The optimizations make the intermediate representation more efficient for subsequent stages of processing or interpretation. The intermediate representation is between the high-level source code and the low-level machine code, allowing the process (300) to perform platform-independent analysis.

Generating the example representation may further include filtering the set of nodes to generate a filtered set of nodes corresponding to the operations, corresponding to the defect. The filtered set of nodes may include notes that are relevant to the defect. For example, certain types of defects may correspond to certain types of instructions represented as nodes in the graph. The nodes that correspond to instructions that do not correspond to the defect may be removed from the intermediate representation.

Step (305) includes combining an explanation section, an instruction section, and a description section to generate a prompt. The different sections may be loaded, appended together, and stored back to a repository. The explanation section includes the example representation, the instruction section includes instruction text, and the description section includes defect description text. The defect description text includes a natural language description of a defect corresponding to the example representation. The example representation may include the defect and does include operations corresponding to the defect. The explanation section includes operations corresponding to the defect. The instruction text includes instructions in the natural language to generate defect checker code using the example representation and the defect description text.

A finite state machine for a type of defect may be displayed. The display of the finite state machine of the defect may include multiple states and transitions. Certain transitions from certain states may be identified as a defect. Additionally, an ending state may be identified such that if the code does not end in the selected ending state, then a defect is present.

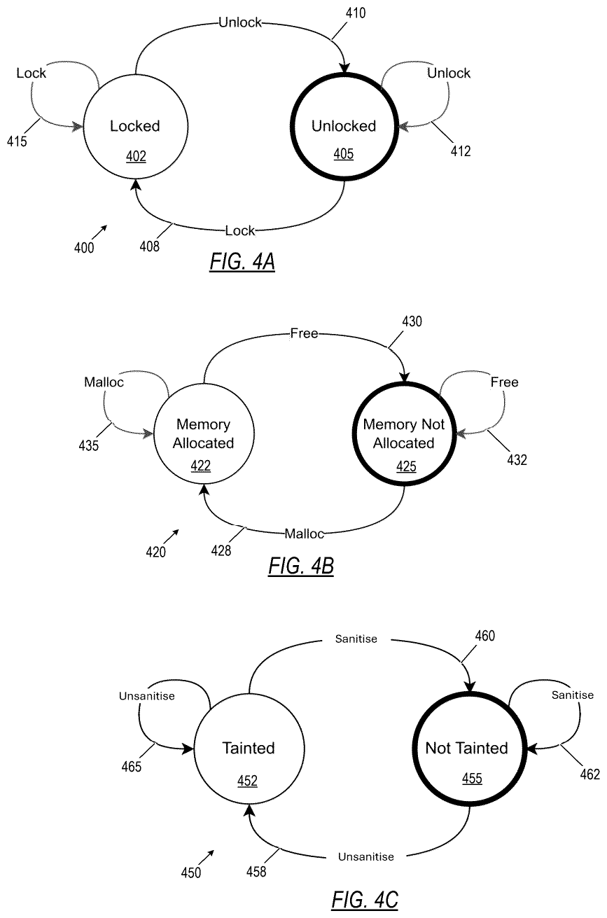

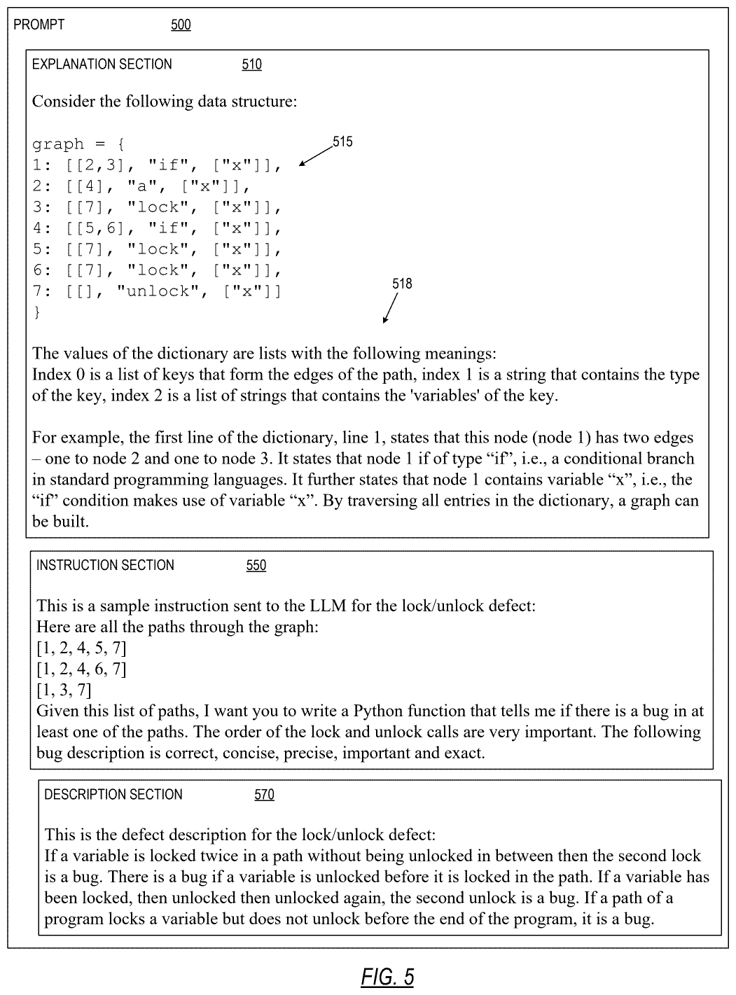

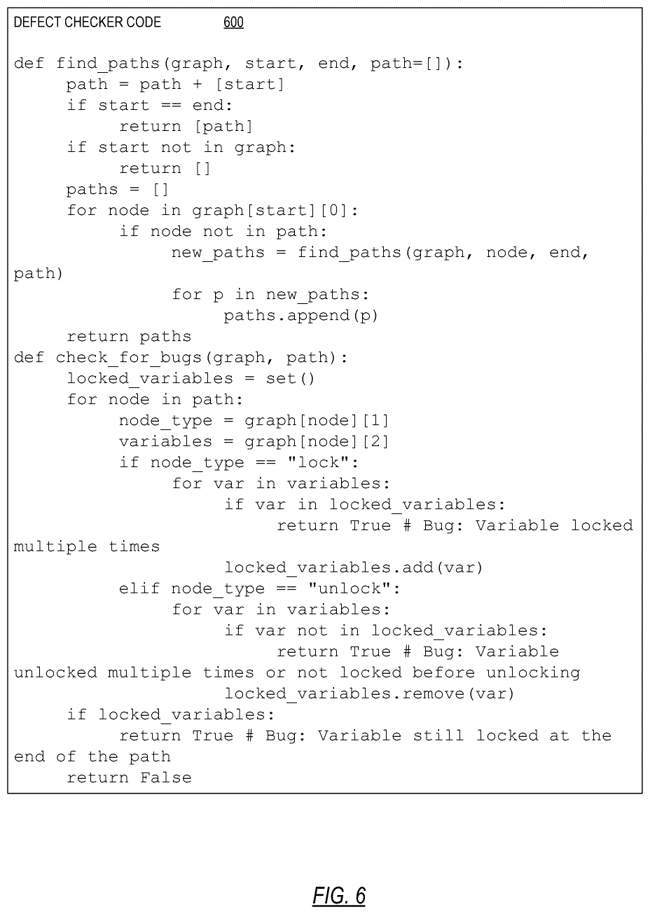

The defect may be one or more of a lock defect, a memory allocation defect, and a tainted defect. A lock defect may be present when a variable has not been properly locked or unlocked and as further described with FIG. 4A. A memory allocation defect may be present when memory has not been properly allocated and as further described with FIG. 4B. A taint defect may be present when a variable that is tainted is accessed and as further described with FIG. 4C. Other defects of different types may also be included.

Combining the explanation section, the instruction section, and the description section to generate the prompt may include appending the instruction section to the explanation section. The explanation section includes explanation text in the natural language describing the example representation. The explanation section may be an initial section of the prompt and the instruction section may be a section of the prompt that is subsequent to the explanation section. Different ordering may be used.

Combining the explanation section, the instruction section, and the description section to generate the prompt may further include appending the description section to the instruction section. The description section may be subsequent to the instruction section. The description section may be an end section. Different ordering may be used.

Step (308) includes executing a language model using the prompt to generate the defect checker code. The defect checker code is in a programming language. The language model may tokenize and vectorize the text of the prompt. The tokenization and vectorization of text may be performed by an embedding model to generate vectors from text. The embedding model may include a tokenizer that converts sequences of one or more characters of text into individual tokens. Each token may be an integer that uniquely identifies a sequence of text. Each token may be converted into a vector (referred to as a token vector) that includes a set of real values. The token vectors (generated from the tokens and extracted from the text) create a semantic space in which the vectors within the semantic space correlate to the meanings of the words or phrases represented by the token vectors. Words with similar meaning from the text may be represented by vectors with similar values and corresponding positions within the semantic space. The vectors may be input to the machine learning model of the language model to generate output vectors. The output vectors may be converted to tokens, which are then converted to text that is output by the language model. The text output from their language model is the defect checker code, which is written in a programming language and may be compiled and executed.

The process (300) may further include testing the defect checker code with samples of intermediate representations that may be generated from code samples, including the example code to generate an accuracy score of the defect checker code. The code samples may include a set of positive test cases that evaluate to true when the defect is present and a set of negative test cases that evaluate to false when the defect is present. The accuracy score may be the average of the number of code samples correctly identified by the defect checker code.

The process (300) may further include preventing deployment of defect checker code after comparing the accuracy score to an accuracy threshold. When the accuracy score of the defect check code is below the accuracy threshold, deployment of the defect checker code may be prevented. For example, the defect checker code may be labeled as “not deployable”, which when identified by a deployment pipeline process, prevents the deployment pipeline process from compiling or transmitting the defect checker code to computing systems of a production environment.

The process (300) may further include testing multiple defect checker codes, including the defect checker code, with code samples including the example code to generate multiple accuracy scores. An accuracy score of the multiple accuracy scores represents an accuracy of the defect checker code.

The process (300) may further include selecting the defect checker code using the accuracy score. The defect checker code with the highest accuracy score may be selected for deployment to computing systems of a production environment.

Turning to FIG. 3B, the process (350) may be part of an application that uses defect checker code. The process (350) may include multiple steps (e.g., steps (352) through (355)) that may execute on the components described in the other figures, including those of FIG. 1.

Step (352) includes executing the intermediator using test code to generate a test representation from the test code. The intermediator may process the test code in a manner similar to how the example code was processed. The intermediator may generate a control flow graph from the test code that is then filtered down to a filtered graph that includes nodes for instructions that relate to the defect to be checked within the test code by the defect checker code.

Step (355) includes executing the defect checker code using a test representation, which may be generated from test code to generate a defect report. The defect report indicates a presence of the defect within the test code. When a defect is identified as present, the defect report may have a result of true or positive. When a defect is not identified as present, the defect report may have a result of false or negative. The defect report may be stored to the repository and transmitted to a user device for display.

FIG. 4A through FIG. 4C illustrate examples of finite state machines for different types of defects. Each of these finite state machines may be displayed on a user device.

Turning to FIG. 4A, in accordance with an example of the disclosure, the finite state machine (400) may be used to detect a lock defect. A lock prevents access to a variable. A lock defect occurs when a variable is locked or unlocked twice in a row or the program ends with the variable locked.

The finite state machine (400) includes the states (402) and (405) and the transitions (408), (410), (412), and (415). The states identify the status of variables in source code being checked using the finite state machine (400). The locked state (402) indicates that a variable has been locked and may not be accessible to other processes. The unlock state (405) indicates that a variable is unlocked and may be accessible to other processes. The transitions (408) and (410) between the locked state (402) and the unlocked state (405) are permissible transitions. The transitions (412) and (415), from a state to the same state, are impermissible and indicative of a defect in the code. Additionally, the unlocked state (405) is identified as an accept state illustrated with a thicker line around the state (405) than for the line around the state (402). If the code being analyzed ends with the status of the variable in the unlocked state (405), then there is no defect. If the code being analyzed ends with the status of the variable in the locked state (402), then the code includes a defect.

Turning to FIG. 4B, in accordance with an example of the disclosure, the finite state machine (420) may be used to detect a memory allocation defect. Memory is allocated to variables during the execution of the code. A memory allocation defect occurs when allocated memory is allocated again, when free memory was attempted to be freed again, and when the program ends with memory that has been allocated but not freed.

The finite state machine (420) includes the states (422) and (425) and the transitions (428), (430), (432), and (435). The states identify the allocation status of memory used by the code being checked using the finite state machine (420). The allocated state (422) indicates that memory has been allocated to a variable. The not allocated state (425) indicates that memory has not been allocated to a variable. The transitions (428) and (430) between the allocated state (422) and the not allocated state (425) are permissible transitions. The transitions (432) and (435), from a state to the same state, are impermissible and indicative of a defect in the code. Additionally, the not allocated state (425) is identified as an accept state illustrated with a thicker line around the state (425) than for the line around the state (422). If the code being analyzed ends with memory in the not allocated state (425), then there is no defect. If the code being analyzed ends with memory in the allocated state (422), then the code includes a defect.

Turning to FIG. 4C, in accordance with an example of the disclosure, the finite state machine (450) may be used to detect a tainted defect. A variable may be “tainted” when the variable is accessed by a tainted source and is not tainted when the variable has not been accessed by a tainted source. A tainted source may be a potentially malicious process, such as a process that receives input from a user. A tainted variable may be sanitized to remove the taint from having been accessed by a potential and monstrous process.

The finite state machine (450) includes the states (452) and (455) and the transitions (458), (460), (462), and (465). The states identify the taint status of variables used by the code being checked using the finite state machine (450). The tainted state (452) indicates that the variable has been accessed by a potentially malicious process. The not tainted state (455) indicates that the variable has not been accessed by a potentially malicious process. The transitions (458) and (460) between the tainted state (452) and the not tainted state (455) are permissible transitions. The transitions (462) and (465), from a state to the same state, are also permissible. The not tainted state (455) is identified as an accept state illustrated with a thicker line around the state (455) than for the line around the state (452). If the code being analyzed ends with a variable in the not tainted state (455), then there is no defect. If the code being analyzed ends with the variable in the tainted state (452), then the code includes a defect.

Turning to FIG. 5, in accordance with an example of the disclosure, the prompt (500) may be used to generate defect checker code from a language model. The prompt (500) is an example of a prompt to generate defect checker code for a lock defect, such as the one described with FIG. 4A. The prompt (500) includes the explanation section (510), the instruction section (550), and the description section (570).

The explanation section (510) provides examples of intermediate representations of code that may be checked with the defect checker code generated from the prompt (500). The explanation section (510) includes the graph (515) and the explanation text (518).

The graph (515) is a textual version of an intermediate representation of programming language code for a program. The graph (515) is written using a programming language using a dictionary data structure to provide the intermediate representation. The dictionary data structure uses key value pairs to organize content in which a key may be used to provide access to the value that corresponds to the key. The intermediate representation is a graph with nodes represented as keys in the key value pairs of the dictionary labeled as the keys “1” through “7”. Each value for a key in the dictionary includes a tuple with additional information about the graph. The first element of the tuple (at “index 0”) is a list of the nodes that are connected to the node identified by the key. Each connection is referred to as an edge. The second element of the tuple (at “index 1”) identifies an instruction from the code used to generate the intermediate representation. The instructions are instructions that relate to the lock defect and include the instructions “if”, “a”, “lock”, and “unlock”. The third element of the tuple (at “index 2”) identifies a variable used with the instruction of the second element of the tuple.

The explanation text (518) is a natural language text that may describe the contents of the intermediate representation. The explanation text (518) provides a natural language description of the meaning of the data and structure within the graph (515).

The instruction section (550) includes instructions that may direct a language model to generate defect checker code. The instruction section (550) includes natural language text with the instruction to generate defect checker code (e.g., “. . . write a function written in the Python function . . . ”). The instruction section (550) references both the explanation section (510) and the description section (570).

The description section (570) includes a description of the type of defect that the output of the language model (the defect checker code) will be used to check. The description section (570) includes a natural language description of the lock defect described in the FIG. 4A.

Turning to FIG. 6, in accordance with an example of the disclosure, the defect checker code (600) is one example of output from a language model in response to the prompt (500) of FIG. 5. The defect checker code (600) is written in a programming language that may be compiled and executed to analyze and test code for a defect of the type described with the prompt (500) of FIG. 5. The defect checker code (600) includes two functions. The initial function labeled “find paths” finds the paths through the intermediate representation of the code being tested. The subsequent function labeled “check_for_bugs” checks for bugs in the paths identified with the initial function.

Turning to FIG. 7, in accordance with an example of the disclosure, an example is illustrated of using defect checker code. The defect checker code (600) may be executed to analyze the test representation in (720) (produced from the test code (700)) and generates the defect report (750).

The test code (700) is the code to be tested for a defect. The test code (700) may be filtered from a larger set of code (file or set of files) down to the instructions that relate to the type of defect being checked. The test code (700) includes instructions for locking and unlocking the variable x and may be checked for a lock defect.

The test representation (720) is an intermediate representation of the test code (700). The test representation (720) may be generated by a developer. Additionally, the test representation (720) may be generated by an intermediator (i.e., a program) that converts the code from the test code (700) to an intermediate representation, which may be a control flow graph. The initial intermediate representation generated from the test code (700) may be filtered down to a representation that includes the instructions related to the type of defect being checked. The test representation (720) is processed with the defect checker code (600) (of FIG. 6) to determine whether the test code (700) includes the type of defect described in the prompt (500) (of FIG. 5) and generate the defect report (750). The output of the analysis is the defect report (750).

The defect report (750) provides a description of the analysis of the test representation (720) for the test code (700). The defect report (750) may be generated after executing the defect checker code (600) of FIG. 6 with the test representation (720) to analyze the test representation (720). The defect report (750) may be written in a natural language and indicates that the type of defect described in the prompt (500) (of FIG. 5) was not found in the test representation (720) and should not be in the test code (700). If the defect was found in one or more locations in the test code (700), then the defect report (750) may identify each location where the defect was found.

Embodiments may be implemented on a special purpose computing system specifically designed to achieve the improved technological result. Turning to FIGS. 8A and 8B, the special purpose computing system (800) may include one or more computer processors (802), non-persistent storage (804), persistent storage (806), a communication interface (812) (e.g., Bluetooth interface, infrared interface, network interface, optical interface, etc.), and numerous other elements and functionalities that implement the features and elements of the disclosure. The computer processor(s) (802) may be an integrated circuit for processing instructions. The computer processor(s) may be one or more cores or micro-cores of a processor. The computer processor(s) (802) includes one or more processors. The one or more processors may include a central processing unit (CPU), a graphics processing unit (GPU), a tensor processing unit (TPU), combinations thereof, etc.

The input device(s) (810) may include a touchscreen, keyboard, mouse, microphone, touchpad, electronic pen, or any other type of input device. The input device(s) (810) may receive inputs from a user that are responsive to data and messages presented by the output device(s) (808). The inputs may include text input, audio input, video input, etc., which may be processed and transmitted by the computing system (800) in accordance with the disclosure. The communication interface (812) may include an integrated circuit for connecting the computing system (800) to a network (not shown) (e.g., a local area network (LAN), a wide area network (WAN) such as the Internet, mobile network, or any other type of network), and/or to another device, such as another computing device.

Further, the output device(s) (808) may include a display device, a printer, external storage, or any other output device. One or more of the output device(s) (808) may be the same or different from the input device(s) (810). The input device(s) (810) and the output device(s) (808) may be locally or remotely connected to the computer processor(s) (802). Many different types of computing systems exist, and the aforementioned input device(s) (810) and output device(s) (808) may take other forms. The output device(s) (808) may display data and messages that are transmitted and received by the computing system (800). The data and messages may include text, audio, video, etc., and include the data and messages described above in the other figures of the disclosure.

Software instructions in the form of computer readable program code to perform embodiments may be stored, in whole or in part, temporarily or permanently, on a non-transitory computer readable medium such as a CD, DVD, storage device, a diskette, a tape, flash memory, physical memory, or any other computer readable storage medium. Specifically, the software instructions may correspond to computer readable program code that, when executed by a processor(s), is configured to perform one or more embodiments, which may include transmitting, receiving, presenting, and displaying data and messages described in the other figures of the disclosure.

The computing system (800) in FIG. 8A may be connected to or be a part of a network. For example, as shown in FIG. 8B, the network (820) may include multiple nodes (e.g., node X (822) and node Y (824)). Each node may correspond to a computing system, such as the computing system (800) shown in FIG. 8A, or a group of nodes combined may correspond to the computing system (800) shown in FIG. 8A. By way of an example, embodiments may be implemented on a node of a distributed system that is connected to other nodes. By way of another example, embodiments may be implemented on a distributed computing system having multiple nodes, where each portion may be located on a different node within the distributed computing system. Further, one or more elements of the aforementioned computing system (800) may be located at a remote location and connected to the other elements over a network.

The nodes (e.g., node X (822) and node Y (824)) in the network (820) may be configured to provide services for a client device (826), including receiving requests and transmitting responses to the client device (826). For example, the nodes may be part of a cloud computing system. The client device (826) may be a computing system, such as the computing system (800) shown in FIG. 8A. Further, the client device (826) may include and/or perform all or a portion of one or more embodiments of the disclosure.

The computing system (800) of FIG. 8A may include functionality to present raw and/or processed data, such as results of comparisons and other processing. For example, presenting data may be accomplished through various presenting methods. Specifically, data may be presented by being displayed in a user interface, transmitted to a different computing system, and stored. The user interface may include a GUI that displays information on a display device. The GUI may include various GUI widgets that organize what data is shown as well as how data is presented to a user. Furthermore, the GUI may present data directly to the user, e.g., data presented as actual data values through text, or rendered by the computing device into a visual representation of the data, such as through visualizing a data model.

As used herein, the term “connected to” contemplates multiple meanings. A connection may be direct or indirect (e.g., through another component or network). A connection may be wired or wireless. A connection may be temporary, permanent, or semi-permanent communication channel between two entities.

The various descriptions of the figures may be combined and may include or be included within the features described in the other figures of the application. The various elements, systems, components, and steps shown in the figures may be omitted, repeated, combined, and/or altered as shown from the figures. Accordingly, the scope of the present disclosure should not be considered limited to the specific arrangements shown in the figures.

In the application, ordinal numbers (e.g., first, second, third, etc.) may be used as an adjective for an element (i.e., any noun in the application). The use of ordinal numbers is not to imply or create any particular ordering of the elements, nor to limit any element to being a single element unless expressly disclosed, such as by the use of the terms “before”, “after”, “single”, and other such terminology. Rather, the use of ordinal numbers is to distinguish between the elements. By way of an example, a first element is distinct from a second element, and the first element may encompass more than one element and succeed (or precede) the second element in an ordering of elements.

Further, unless expressly stated otherwise, or is an “inclusive or” and, as such includes “and.” Further, items joined by an “or” may include any combination of the items with any number of each item unless expressly stated otherwise.

In the above description, numerous specific details are set forth in order to provide a more thorough understanding of the disclosure. However, it will be apparent to one of ordinary skill in the art that the technology may be practiced without these specific details. In other instances, well-known features have not been described in detail to avoid unnecessarily complicating the description. Further, other embodiments not explicitly described above may be devised which do not depart from the scope of the claims as disclosed herein. Accordingly, the scope should be limited only by the attached claims.

What is claimed is:

1. A method comprising:
generating an example representation;
combining an explanation section, an instruction section, and a description section to generate a prompt, wherein the explanation section comprises the example representation, the instruction section comprises instruction text, and the description section comprises defect description text, wherein the defect description text comprises a natural language description of a defect corresponding to the example representation, wherein the explanation section comprises operations corresponding to the defect, and wherein the instruction text comprises instructions in the natural language to generate defect checker code using the example representation and the defect description text; and
executing a language model using the prompt to generate the defect checker code, wherein the defect checker code is in a programming language.

2. The method of claim 1, wherein generating the example representation comprises:
executing an intermediator using example code to generate the example representation from the example code.

3. The method of claim 1, wherein generating the example representation comprises:
converting example code to a graph comprising a set of nodes representing operations corresponding to the example code and comprising a set of edges between the set of nodes representing execution paths within the example code; and
filtering the set of nodes to generate a filtered set of nodes corresponding to the operations corresponding to the defect.

4. The method of claim 1, wherein combining the explanation section, the instruction section, and the description section to generate the prompt comprises:
appending the instruction section to the explanation section, wherein the explanation section comprises explanation text in the natural language describing the example representation.

5. The method of claim 1, wherein combining the explanation section, the instruction section, and the description section to generate the prompt comprises:
appending the description section to the instruction section.

6. The method of claim 1, wherein the defect is one or more of a lock defect, a memory allocation defect, and a tainted defect.

7. The method of claim 1, further comprising:
executing an intermediator using test code to generate a test representation from the test code.

8. The method of claim 1, further comprising:
executing the defect checker code using a test representation generated from test code to generate a defect report, wherein the defect report indicates a presence of the defect within the test code.

9. The method of claim 1, further comprising:
testing the defect checker code with code samples comprising example code to generate an accuracy score of the defect checker code, wherein the code samples comprise a set of positive test cases that evaluate to true when the defect is present and a set of negative test cases that evaluate to false when the defect is present; and
preventing deployment of defect checker code after comparing the accuracy score to an accuracy threshold.

10. The method of claim 1, further comprising:
testing a plurality of defect checker codes, comprising the defect checker code, with code samples comprising example code to generate a plurality of accuracy scores, wherein an accuracy score of the plurality of accuracy scores represents an accuracy of the defect checker code; and
selecting the defect checker code using the accuracy score.

11. A system comprising
at least one processor; and
an application that, when executing on the at least one processor, performs operations comprising:
generating an example representation;
combining an explanation section, an instruction section, and a description section to generate a prompt, wherein the explanation section comprises the example representation, the instruction section comprises instruction text, and the description section comprises defect description text, wherein the defect description text comprises a natural language description of a defect corresponding to the example representation, wherein the explanation section comprises operations corresponding to the defect, and wherein the instruction text comprises instructions in the natural language to generate defect checker code using the example representation and the defect description text; and
executing a language model using the prompt to generate the defect checker code, wherein the defect checker code is in a programming language.

12. The system of claim 11, wherein generating the example representation comprises:
executing an intermediator using example code to generate the example representation from the example code.

13. The system of claim 11, wherein generating the example representation comprises:
converting example code to a graph comprising a set of nodes representing operations corresponding to the example code and comprising a set of edges between the set of nodes representing execution paths within the example code; and
filtering the set of nodes to generate a filtered set of nodes corresponding to the operations corresponding to the defect.

14. The system of claim 11, wherein combining the explanation section, the instruction section, and the description section to generate the prompt comprises:
appending the instruction section to the explanation section, wherein the explanation section comprises explanation text in the natural language describing the example representation.

15. The system of claim 11, wherein combining the explanation section, the instruction section, and the description section to generate the prompt comprises:
appending the description section to the instruction section.

16. The system of claim 11, wherein the defect is one or more of a lock defect, a memory allocation defect, and a tainted defect.

17. The system of claim 11, wherein the application performs operations further comprising:
executing an intermediator using test code to generate a test representation from the test code.

18. The system of claim 11, wherein the application performs operations further comprising:
executing the defect checker code using a test representation generated from test code to generate a defect report, wherein the defect report indicates a presence of the defect within the test code.

19. The system of claim 11, wherein the application performs operations further comprising:
testing the defect checker code with code samples comprising example code to generate an accuracy score of the defect checker code, wherein the code samples comprise a set of positive test cases that evaluate to true when the defect is present and a set of negative test cases that evaluate to false when the defect is present; and
preventing deployment of defect checker code after comparing the accuracy score to an accuracy threshold.

20. A non-transitory computer readable medium comprising instructions executable by at least one processor to perform operations comprising:
generating an example representation;
combining an explanation section, an instruction section, and a description section to generate a prompt, wherein the explanation section comprises the example representation, the instruction section comprises instruction text, and the description section comprises defect description text, wherein the defect description text comprises a natural language description of a defect corresponding to the example representation, wherein the explanation section comprises operations corresponding to the defect, and wherein the instruction text comprises instructions in the natural language to generate defect checker code using the example representation and the defect description text; and
executing a language model using the prompt to generate the defect checker code, wherein the defect checker code is in a programming language.
